(19) United States
(12) Patent Application Publication
(10) Pub. No.: US 2023/0401203 A1
(43) Pub. Date: Dec. 14, 2023

(54) Domain-Agnostic Natural Language Processing Using Explainable Interpretation Feedback Models

(71) Applicant: INTERNATIONAL BUSINESS MACHINES CORPORATION, ARMONK, NY (US)

(72) Inventors: YAZAN OBEIDI, Markham (CA); Jaydeep Sen, Bangalore (IN); Tarun Tater, Mundwa (IN); Vatche Isahagian, Belmont, MA (US); Vinod Muthusamy, Austin, TX (US)

(21) Appl. No.: 17/804,143

(22) Filed: May 26, 2022

(51) Int. Cl. G06F 16/242; G06F 16/248; G06F 40/30; G06N 5/04

(52) U.S. Cl. CPC G06F 16/243; G06N 5/04; G06F 40/30; G06F 16/248

(57) ABSTRACT

An embodiment including a domain-agnostic natural language processing system for processing natural language queries having an explainable interpretation feedback model is provided. The embodiment may include receiving a natural language query. The embodiment may also include to automatically detecting whether the received natural language query includes implicit intent therein. The embodiment may include, in response to detecting implicit intent in the received natural language query, automatically generating a modified query including a default inference from an interpretation fact sheet. The embodiment may further include automatically presenting the modified query to the user and asking the user for feedback on the modified query. The embodiment may also include automatically generating a final output if the modified query was approved, or automatically determining an alternative inference and presenting a further modified query including the alternative inference to the user if the modified query was rejected.

### BACKGROUND

The present application relates generally to the field of computing, and more particularly to a domain-agnostic natural language processing system for processing natural language queries having an explainable interpretation feedback model.

Structured Query Language (SQL) is a standard query language to retrieve information stored in relational databases. Common Relational Database Management Systems (RDBMS) use SQL and have their own proprietary extensions. Hence, users need to learn the query language and be familiar with the database management system and database schema to formulate the query to produce the desired output query results. Natural Language Processing (NLP) is a field of computer science, artificial intelligence, and linguistics concerned with the interactions between computers and human (natural) languages. A user having no technical background benefits greatly from having the ability to query a database using natural language queries.

### SUMMARY

According to one embodiment, a method, computer system, and computer program product for processing natural language queries is provided. The embodiment may include receiving a natural language query. The embodiment may also include automatically detecting whether the received natural language query includes an implicit intent using a reasoning engine, wherein the reasoning engine includes domain-agnostic algorithms having domain-agnostic reasoning axioms. The embodiment may also include, in response to detecting implicit intent in the received natural language query, automatically generating a modified query including a default inference from an interpretation fact sheet. The embodiment may further include automatically presenting the modified query to the user and prompt the user to provide user feedback on the modified query. The embodiment may also include, in response to receiving user feedback on the modified query, automatically generating a final output if the modified query was approved, or automatically determining an alternative inference and presenting a further modified query including the alternative inference to the user if the modified query was rejected. The embodiment may further include automatically storing information obtained from the feedback in a fact history repository.

### BRIEF DESCRIPTION OF THE SEVERAL VIEWS OF THE DRAWINGS

These and other objects, features and advantages of the present disclosure will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2A illustrates a first portion of an operational flowchart for processing natural language queries according to at least one embodiment;

FIG. 2B illustrates a second portion of the operation flowchart for processing natural language queries according to at least one embodiment shown in FIG. 2A;

FIG. 3 is a functional block diagram of internal and external components of computers and servers depicted in FIG. 1 according to at least one embodiment;

FIG. 4 depicts a cloud computing environment according to an embodiment of the present invention; and

FIG. 5 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. The present disclosure may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present application relate to the field of natural language processing, and more particularly to a domain-agnostic natural language processing system for processing natural language queries that utilizes an explainable interpretation feedback model. The following described exemplary embodiments provide a system, method, and program product to, among other things, receive a natural language query, automatically detect whether the received natural language query includes an implicit intent by using a reasoning engine, wherein the reasoning engine including domain-agnostic algorithms having domain-agnostic reasoning axioms, generate a modified query including a default inference to provide to the user, and iteratively obtaining user feedback and modifying the natural language query until approved by the user to generate a final output to the received natural language query. The present embodiment has the capacity to improve natural language processing technology by allowing users to provide feedback based on the system's explainable interpretation of the received natural language query. The present embodiment has the capacity to further improve natural language processing technology by providing an improved natural language processing system that is domain-agnostic, allowing a user to bring their own data setup to engage with the natural language processing system.

As previously described, Structured Query Language is a standard query language to retrieve information stored in relational databases. Common Relational Database Management Systems use SQL and have their own proprietary extensions. Hence, users need to learn the query language and be familiar with the database management system and database schema to formulate the query to produce the desired output query results. It is often challenging for non-technical end users to query relational databases without being trained technically. Therefore, many systems aim to convert Natural Language Queries (NLQ) into SQL queries to provide a more user-friendly experience. Generally, people use natural language to communicate and ask questions in the real world. Natural Language Processing (NLP) is a field of computer science, artificial intelligence, and linguistics concerned with the interactions between computers and human (natural) languages. As such, NLP is often involved with natural language understanding, i.e., enabling computers to derive meaning from human or natural language input, and natural language generation.

Many users input natural language queries into question-answering (QA) systems to obtain information. Typically, natural language QA systems are domain-specific regarding what data they access and interact with. Thus, many natural language QA systems are manually customized to allow its users to input queries to obtain information in a specific domain (e.g. Finance, healthcare, etc.) Some natural language QA systems are designed to obtain feedback from users to help improve the natural language QA system. However, feedback in conventional natural language QA systems is typically related to an output or answer obtained by the natural language QA system and not an explanation of how the system interpreted a received natural language query. Accordingly, typical natural language QA systems are unable to improve the interpretation of received natural language queries without costly manual correction of the system by a trained professional. Furthermore, typical natural language QA systems have a professional manually pre-populate a domain ontology before deploying the system, demanding extra time and effort to deploy for a given domain. It would therefore be advantageous to provide a natural language processing system for question answering applications that is domain-agnostic, and can obtain user feedback related to explainability of the system's interpretation of a received natural language query, thereby allowing the system to both self-improve how it interprets queries over time and be used with a variety of domains without the need for human-intensive manual intervention or training. Specifically, the system, method, and program product may receive a natural language query, automatically detect whether the received natural language query includes an implicit intent by using a reasoning engine, wherein the reasoning engine includes domain-agnostic algorithms having domain-agnostic reasoning axioms, generate a modified query including a default inference to provide to the user, and iteratively obtaining user feedback and modifying the natural language query until approved by the user to generate a final output to the received natural language query.

According to at least one embodiment, when a user inputs a natural language query into a computer system capable of employing methods in accordance with the present invention, the method, system, computer program product may automatically detect whether the received natural language query includes an implicit intent by using a reasoning engine, wherein the reasoning engine includes domain-agnostic algorithms having domain-agnostic reasoning axioms. The method, system, computer program product may then, in response to detecting implicit intent in the natural language query, automatically generate a modified query including a default inference from an interpretation fact sheet. Next, the method, system, computer program product may automatically present the modified query to the user and prompt the user to provide feedback on the modified query. According to one embodiment, the method, system, computer program product may then, in response to receiving user feedback on the modified query, automatically generate a final output if the modified query was approved, or automatically determine an alternative inference and present a further modified query including the alternative inference to the user if the modified query was rejected. The method, system, computer program product may then automatically store information obtained from the feedback in a fact history repository. In turn, the received natural language query has been processed by a natural language processing system that is domain-agnostic and can obtain user feedback related to explainability of the natural language processing system's interpretation of a received natural language query. Thus, an exemplary natural language processing system in accordance with this disclosure can both self-improve how it interprets queries over time using the stored explainability data from the user feedback, and also be used with a variety of domains without the need for manual human-intensive intervention or training.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present disclosure are described herein with reference to flowchart illustrations and/or block diagrams of methods, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which includes one or more executable instructions for implementing the specified logical function(s). In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product to process natural language queries using a domain-agnostic natural language processing system having an explainable interpretation feedback model.

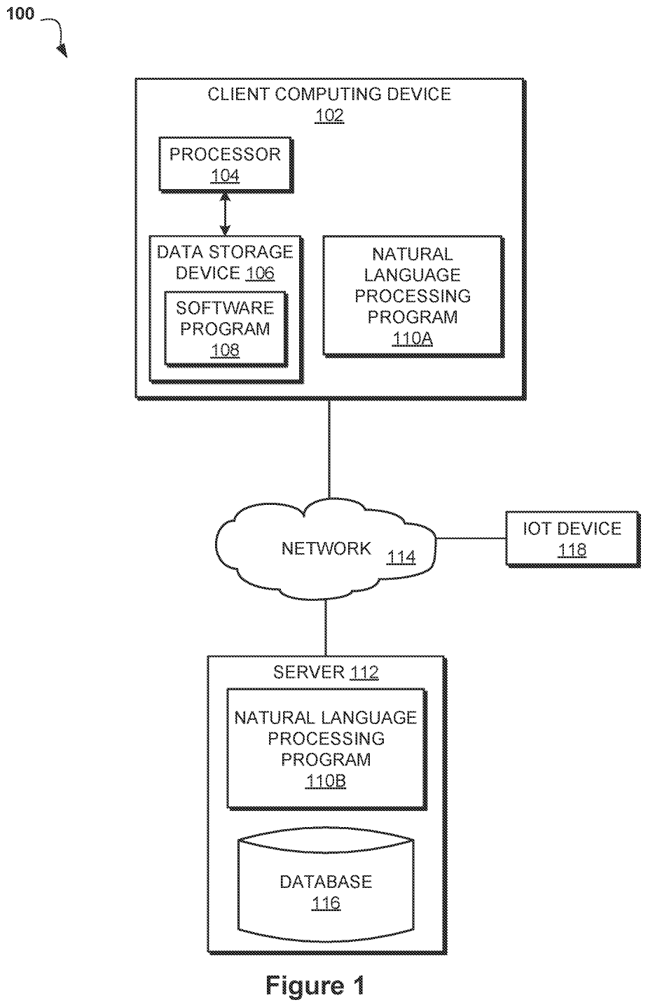

Referring to FIG. 1, an exemplary networked computer environment 100 is depicted, according to at least one embodiment. The networked computer environment 100 may include client computing device 102, a server 112, and Internet of Things (IoT) Device 118 interconnected via a communication network 114. According to at least one implementation, the networked computer environment 100 may include a plurality of client computing devices 102 and servers 112, of which only one of each is shown for illustrative brevity.

The communication network 114 may include various types of communication networks, such as a wide area network (WAN), local area network (LAN), a telecommunication network, a wireless network, a public switched network and/or a satellite network. The communication network 114 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements.

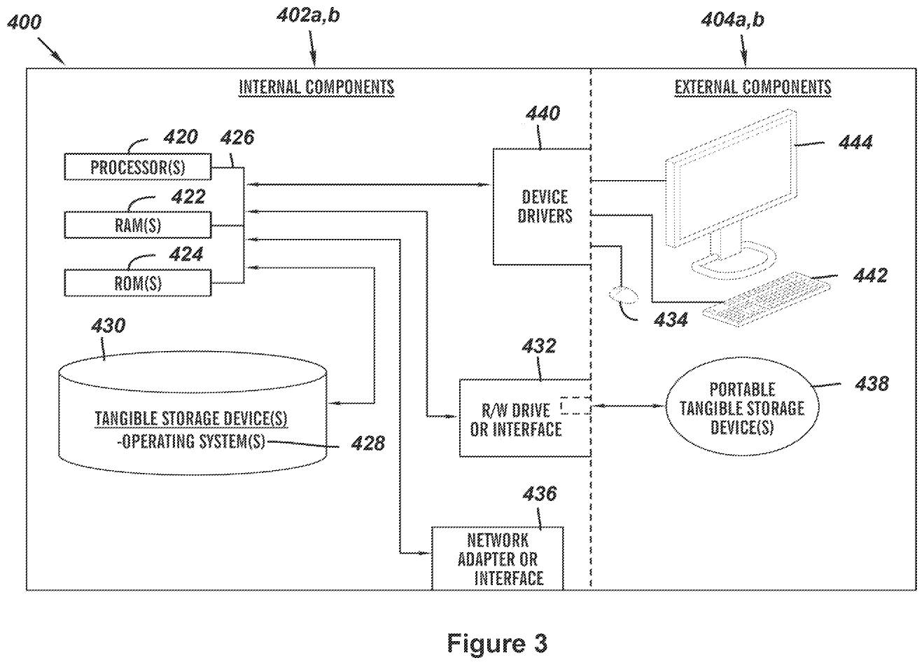

Client computing device 102 may include a processor 104 and a data storage device 106 that is enabled to host and run a software program 108 and a natural language processing program 110A and communicate with the server 112 and IoT Device 118 via the communication network 114, in accordance with one embodiment of the present disclosure. Client computing device 102 may be, for example, a mobile device, a telephone, a personal digital assistant, a netbook, a laptop computer, a tablet computer, a desktop computer, or any type of computing device capable of running a program and accessing a network. As will be discussed with reference to FIG. 3, the client computing device 102 may include internal components 402a and external components 404a, respectively.

The server computer 112 may be a laptop computer, netbook computer, personal computer (PC), a desktop computer, or any programmable electronic device or any network of programmable electronic devices capable of hosting and running a natural language processing program 110B and a database 116 and communicating with the client computing device 102 and IoT Device 118 via the communication network 114, in accordance with embodiments of the present disclosure. As will be discussed with reference to FIG. 3, the server computer 112 may include internal components 402b and external components 404b, respectively. The server 112 may also operate in a cloud computing service model, such as Software as a Service (SaaS), Platform as a Service (PaaS), or Infrastructure as a Service (IaaS). The server 112 may also be located in a cloud computing deployment model, such as a private cloud, community cloud, public cloud, or hybrid cloud.

IoT Device 118 may be a mobile device, a voice-controlled personal assistant, and/or any other IoT Device 118 known in the art for receiving queries that is capable of connecting to the communication network 114, and transmitting and receiving data with the client computing device 102 and the server 112.

According to the present embodiment, the natural language processing program 110A, 110B may be a program capable of receiving a natural language query. Natural language processing program 110A, 110B may then automatically pass the received natural language query through a reasoning engine, the reasoning engine including domain agnostic reasoning axioms, to automatically detect whether the received natural language query includes implicit intent therein. Next, natural language processing program 110A, 110B may then, in response to detecting implicit intent in the received natural language query, automatically generate a modified query including a default inference from an interpretation fact sheet. Next, natural language processing program 110A, 110B may then present the modified query to the user and ask the user for feedback on the modified query. Then, natural language processing program 110A, 110B, in response to receiving user feedback on the modified query, may automatically generate a final output if the modified query was approved, or may automatically determine an alternative inference and present a further modified query including the alternative inference to the user if the modified query was rejected. Finally, natural language processing program 110A, 110B may automatically store information obtained from the feedback in a fact history repository. In turn, the received natural language query has been processed by a system that is domain-agnostic, and can obtain user feedback related to explainability of the system's interpretation of a received natural language query, thereby allowing the system to both self-improve how it interprets queries over time and be used with a variety of domains without the need for human-intensive manual intervention or training.

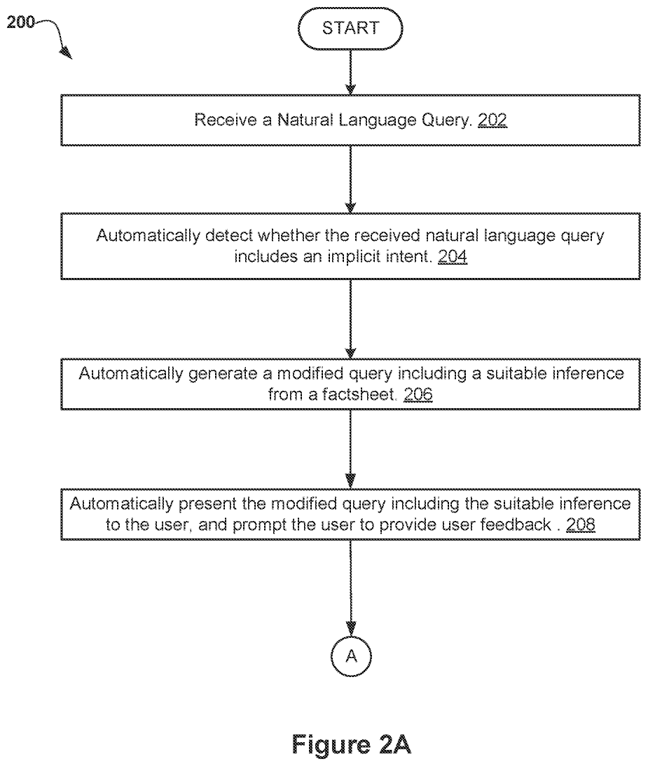

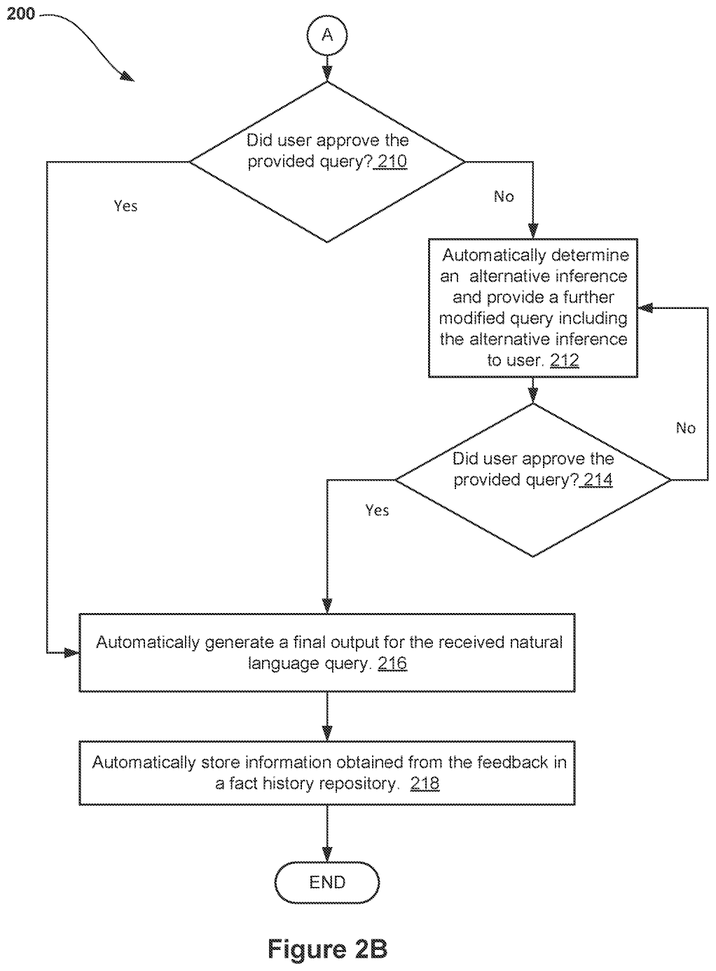

Referring now to FIG. 2, an operational flowchart for processing natural language queries using a domain-agnostic natural language query process 200 having an explainable interpretation feedback model is depicted according to at least one embodiment. At 202, the natural language processing program 110A, 110B receives a natural language query. The received natural language query may be input into the program via typing, spoken word, or any other suitable mechanism of inputting a natural language query into processing program 110A, 110B. The natural language query may be in the form of a statement or a question. For example, a given user may input ‘I would like to know where Shop X is located” or “Could you please tell me the salary of Employee X?”

At 204, the natural language processing program 110A, 110B 110A, 110B automatically detects whether the received natural language query includes an implicit intent. Natural language processing program 110A, 110B automatically detects whether the received natural language query includes an implicit intent by using a reasoning engine including domain-agnostic algorithms having domain-agnostic reasoning axioms. In the context of this disclosure, implicit intent refers to any received natural language query including language that implies an applicable parameter, function, or configuration without specifically mentioning the parameter, function or configuration. For example, the query “show me companies in California” includes implicit intent to show ‘names of companies’ in California, the implied parameter being ‘names’ of companies. Similarly, a natural language query stating ‘show me revenues of company X in 2020’ includes implicit intent to show ‘total metric value’ of revenue of company X with metric fiscal year of 2020, the implied parameter being the ‘total metric value’.

When natural language processing program 110A, 110B receives a natural language query, natural language processing program 110A, 110B automatically detects whether the received natural language query includes implicit intent therein using domain-agnostic algorithms that contain sets of reasoning axioms (rules) to model a self-sufficient query having the complete intent explicitly specified therein. For example, an axiom may state that a numeric aggregation function may only be applied to a numeric field. These axioms may be written over various concepts in a variety of domains having their own sets of ontologies. When natural language processing program 110A, 110B receives a natural language query, it performs a consistency check to see if the received natural language query follows the domain-agnostic reasoning axioms for an explicitly stated self-sufficient query, or if there is a violation. If the consistency check is passed, then the query is deemed to be self-sufficient because it has complete intent explicitly specified therein. If this consistency check is failed, natural language processing program 110A, 110B will detect that there is implicit intent in the received natural language query and determine that the received natural query should have an inference added to make the query processable. For example, natural language processing program 110A, 110B may detect that a received query includes a time phrase mention without explicit time property, or a numeric aggregation function on a non-numeric property. In each of these cases, natural language processing program 110A, 110B will determine that the received natural language query includes implicit intent therein. The process by which natural language processing program 110A, 110B amends and processes queries including implicit intent therein (i.e. lacking explicit intent) will be further described below.

In embodiments, natural language processing program 110A, 110B may further include corrective actions for various detectable inconsistencies. For example, using domain-agnostic algorithms described above, if natural language processing program 110A, 110B detects that a numeric comparison is being made on a concept instead of a numeric property, then natural language processing program 110A, 110B may apply a corresponding corrective action that will instead apply the numeric comparison to the default measure property of the concept. Once natural language processing program 110A, 110B has detected that a received natural language query includes an implicit intent therein, a suitable inference must be added to the received natural language query to make it processable.

At 206, in response to detecting implicit intent in the received natural language query, natural language processing program 110A, 110B automatically generates a modified query including a suitable inference from an interpretation fact sheet. In the context of this disclosure, an interpretation fact sheet is a list of default measurements, parameters, or configurations that can be applied to a domain-specific concept. For example, in a specific domain related to finance or banking, a domain-specific concept may include ‘loans’. In an exemplary interpretation fact sheet for the domain-specific concept of ‘loans’, the interpretation fact sheet may include a variety of default measurements, parameters, or configurations, such as, for example, ‘loan.key_property’, ‘loan.measure’, ‘loan.default group by’, ‘loan.default time’, ‘loan.defaultRank’ etc. In an exemplary received natural language query stating “show me all loans in 2020”, natural language processing program 110A, 110B may generate a modified query including a suitable inference from an interpretation fact sheet which indicates that ‘loan.default time: application_date’. In other words, natural language processing program 110A, 110B will determine that a suitable inference for this exemplary received natural language query should use “application_date” as the implied default time parameter for this received query according to the interpretation fact sheet. Thus, natural language processing program 110A, 110B will produce a modified query including “application_date” as the default time parameter for ‘loans’. Thus, Natural language processing program 110A, 110B utilizes an inference engine that considers the ontology sets of a specific ‘plugged-in’ domain to determine how to apply the interpretation fact sheet in the context of a domain specific concept and a received natural language query to determine the most appropriate default measurements, properties, or configurations to include in a modified query containing an inference. As discussed above, the ability to have domain-agnostic detection of implicit intent and a domain-agnostic interpretation fact sheet that can be used with any specific domain or data set brought in by a user (as described herein) is desirable to minimize costly and time-consuming human intervention typically required to allow for accurate natural language processing for a specific domain.

At 208, natural language processing program 110A, 110B automatically presents the modified query including the suitable inference to the user and prompts the user to provide user feedback. Natural language processing program 110A, 110B provides the modified query to the user via a user interface on client computing device 102 (shown in FIG. 1) along with an explanation of why any inferences or modifications were made to the originally received natural language query. For example, using the same example as above, if natural language processing program 110A, 110B receives the query “show me all loans in 2020”, natural language processing program 110A, 110B may provide the user with the modified query “show me all loans in 2020 with application_date in 2020” and provide an explanation stating that “‘application_date’ has been assumed as the default date for concept loan and used to create filter on time phrase 2020. Do you want to change?” Thus, natural language processing program 110A, 110B has provided a modified query containing a suitable inference to the user from the standardized factsheet as applied to the specific domain, and prompted the user to provide user feedback. It should be noted that the ability of natural language processing program 110A, 110B to provide explainability to the user of how the received natural language query was interpreted by natural language processing program 110A, 110B improves the ability of the user to ensure that their query is likely to ultimately provide the intended output upon being modified if needed.

At 210, natural language processing program 110A, 110B receives feedback from the user deciding whether to approve or reject the modified query. If the user approves the modified query, then natural language processing program 110A, 110B will process the modified query and generate a final query result for the received natural language query at 216. If however, the user rejects the modified query, then natural language processing program 110A, 110B will continue to modify the query to attempt to provide the user with a query that is representative of the information they are seeking to obtain.

If a user rejects the modified query, then at 212, natural language processing program 110A, 110B will automatically determine an alternative inference and provide a further modified query to the user. In practice, revisiting the example from above using the natural language query ‘show me all loans in 2020’, natural language processing program 110A, 110B may present the user with a message stating that “‘application_date’ has been assumed as the default date for concept loan and used to create filter on time phrase 2020. Do you want to change?” If the user responds with ‘yes’, the modified query proposed by natural language processing program 110A, 110B has been rejected. Thus, at 212, natural language processing program 110A, 110B will revisit the domain-specific ontology set and propose an alternative inference. For example, natural language processing program 110A, 110B may output to the user, “Did you mean loan.start date?” At 214, natural language processing program 110A, 110B will again prompt the user to approve or reject the provided query. If the user against rejects the query, natural language processing program 110A, 110B will iteratively repeat the described process at 212 of determining alternative inferences to provide further modified queries to the user. In each instance, natural language processing program 110A, 110B will provide for explainability of its interpretation of each subsequent modified query for the user's benefit. If approved, natural language processing program 110A, 110B will process the finally modified query and generate a final query result for the received natural language query at 216. In some embodiments, natural language processing program 110A, 110B may provide the user with multiple alternative inferences in the form of a drop-down menu from which the user may select the desired parameter to include in a further modified query. In embodiments, all obtained feedback may be used to fine tune the inference engine to improve future queries.

Finally at 218, natural language processing program 110A, 110B will automatically store information obtained from the feedback into a fact history repository. As natural language processing program 110A, 110B continuously stores information in the fact history repository, natural language processing program 110A, 110B can update or modify the interpretation fact sheet to reflect the most commonly used default measurements, parameters, or configurations used in queries for a specific domain being used with natural language processing program 110A, 110B. In embodiments, natural language processing program 110A, 110B may retain information in the fact history repository that is user-specific, for instances in which feedback from a specific user indicates that a specific default measurement, parameter, or configuration is preferred as compared to the preferences of the majority of the users. Natural language processing program 110A, 110B may use the information stored in the fact history repository to automatically generate user-specific confidence scores or various alternative inferences for a concept in a specific domain. Various uses are envisioned for the feedback and information stored in the fact history repository. For example, the information stored in the fact history repository may be used to further improve the inference engine by storing the feedback in a database and indexing the feedback along with the query, the inferred entity, and the user-selected entity. Thus, when a new query is inputted, the new query, along with the group-by terms and other attributes can then be searched by looking up previous examples. In embodiments, natural language processing program 110A, 110B may use stored feedback to develop confidence scores overtime for a plurality of potential inferences, allowing natural language processing program 110A, 110B to favor the use of inferred entities (potential inferences) with relatively high confidence scores as compared to alternative inferences.

Natural language processing program 110A, 110B may also use the information stored in the fact history repository to update the default parameters contained in the domain-agnostic interpretation fact sheet. In embodiments, natural language processing program 110A, 110B includes threshold values in the form of a confidence score or percentage score for determining whether a default measurement, parameter, or configuration is replaced in the interpretation fact sheet for a given domain-specific concept. Thus natural language processing program 110A, 110B is able to update the interpretation fact sheet in view of the information stored in the fact history repository which is obtained from standardized feedback questions to improve its ability to process natural language queries for a specific domain.

In embodiments, natural language processing program 110A, 110B may further interface with a context manager which may keep track of the iterations of a given user's queries, and may optionally collect information from different sources such as previous query logs, past user preferences, past logged events, and any other desired information for optimizing the queries of a given user. Thus, the context manager may help in the inference process described above for queries performed on similar domains, ontologies, or properties across multiple platforms.

It may be appreciated that FIGS. 2A-2B provide only illustrations of an exemplary implementation and do not imply any limitations with regard to how different embodiments may be implemented. Many modifications to the depicted environments may be made based on design and implementation requirements.

FIG. 3 is a block diagram 400 of internal and external components of the client computing device 102 and the server 112 depicted in FIG. 1 in accordance with an embodiment of the present disclosure. It should be appreciated that FIG. 3 provides only an illustration of one implementation and does not imply any limitations with regard to the environments in which different embodiments may be implemented. Many modifications to the depicted environments may be made based on design and implementation requirements.

The data processing system 402, 404 is representative of any electronic device capable of executing machine-readable program instructions. The data processing system 402, 404 may be representative of a smart phone, a computer system, PDA, or other electronic devices. Examples of computing systems, environments, and/or configurations that may represented by the data processing system 402, 404 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The client computing device 102 and the server 112 may include respective sets of internal components 402a,b and external components 404a,b illustrated in FIG. 3. Each of the sets of internal components 402 include one or more processors 420, one or more computer-readable RAMs 422, and one or more computer-readable ROMs 424 on one or more buses 426, and one or more operating systems 428 and one or more computer-readable tangible storage devices 430. The one or more operating systems 428, the software program 108 and the natural language processing program 110A in the client computing device 102 and the natural language processing program 110B in the server 112 are stored on one or more of the respective computer-readable tangible storage devices 430 for execution by one or more of the respective processors 420 via one or more of the respective RAMs 422 (which typically include cache memory). In the embodiment illustrated in FIG. 3, each of the computer-readable tangible storage devices 430 is a magnetic disk storage device of an internal hard drive. Alternatively, each of the computer-readable tangible storage devices 430 is a semiconductor storage device such as ROM 424, EPROM, flash memory or any other computer-readable tangible storage device that can store a computer program and digital information.

Each set of internal components 402a,b also includes a RAY drive or interface 432 to read from and write to one or more portable computer-readable tangible storage devices 438 such as a CD-ROM, DVD, memory stick, magnetic tape, magnetic disk, optical disk or semiconductor storage device. A software program, such as the natural language processing program 110A, 110B, can be stored on one or more of the respective portable computer-readable tangible storage devices 438, read via the respective R/W drive or interface 432, and loaded into the respective hard drive 430.

Each set of internal components 402a,b also includes network adapters or interfaces 436 such as a TCP/IP adapter cards, wireless Wi-Fi interface cards, or 3G or 4G wireless interface cards or other wired or wireless communication links. The software program 108 and the natural language processing program 110A in the client computing device 102 and the natural language processing program 110B in the server 112 can be downloaded to the client computing device 102 and the server 112 from an external computer via a network (for example, the Internet, a local area network or other, wide area network) and respective network adapters or interfaces 436. From the network adapters or interfaces 436, the software program 108 and the natural language processing program 110A in the client computing device 102 and the natural language processing program 110B in the server 112 are loaded into the respective hard drive 430. The network may comprise copper wires, optical fibers, wireless transmission, routers, firewalls, switches, gateway computers and/or edge servers.

Each of the sets of external components 404a,b can include a computer display monitor 444, a keyboard 442, and a computer mouse 434. External components 404a,b can also include touch screens, virtual keyboards, touch pads, pointing devices, and other human interface devices. Each of the sets of internal components 402a,b also includes device drivers 440 to interface to computer display monitor 444, keyboard 442, and computer mouse 434. The device drivers 440, R/W drive or interface 432, and network adapter or interface 436 include hardware and software (stored in storage device 430 and/or ROM 424).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

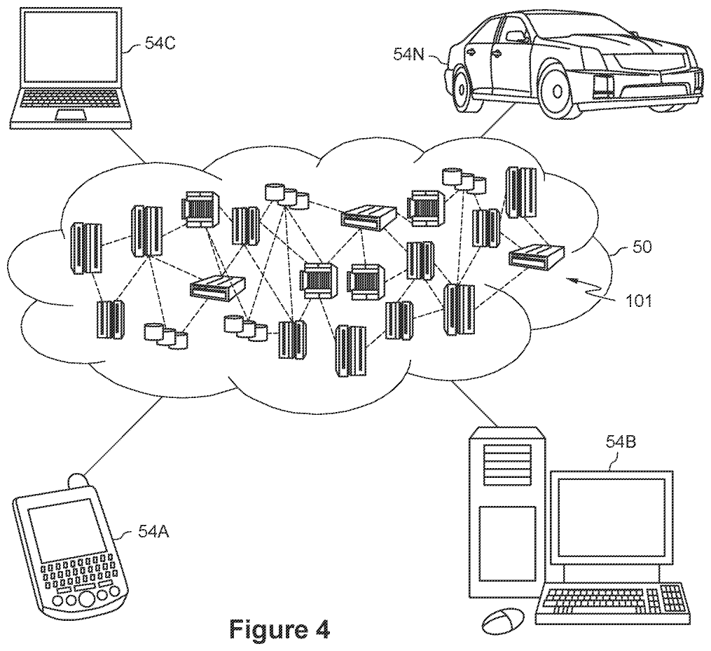

Referring now to FIG. 4, illustrative cloud computing environment 50 is depicted. As shown, cloud computing environment 50 includes one or more cloud computing nodes 101 with which local computing devices used by cloud consumers, such as, for example, personal digital assistant (PDA) or cellular telephone 54A, desktop computer 54B, laptop computer 54C, and/or automobile computer system 54N may communicate. Nodes 101 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 100 and cloud computing environment 50 can communicate with any type of computerized device over any type of network and/or network addressable connection (e.g., using a web browser).

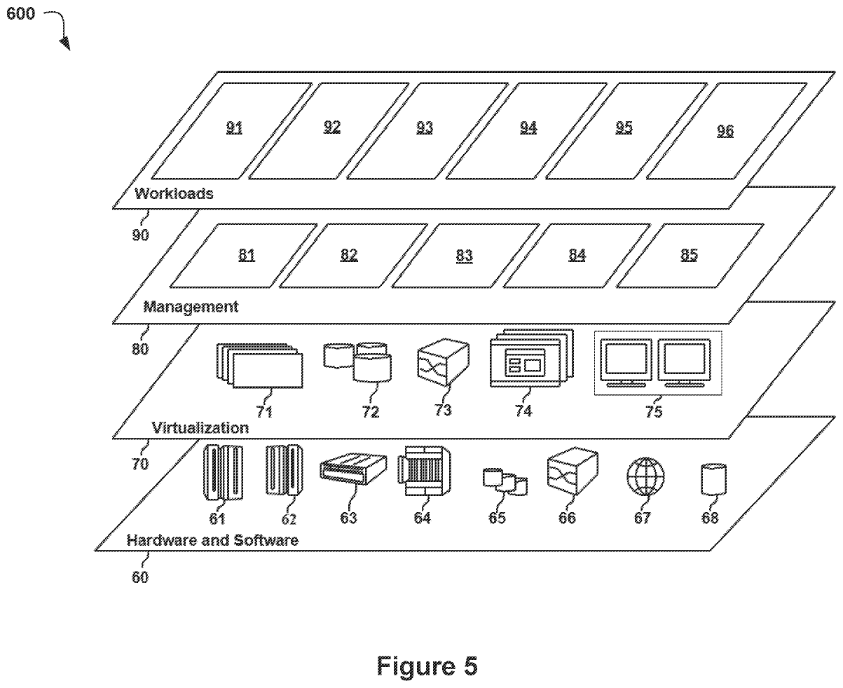

Referring now to FIG. 5, a set of functional abstraction layers 600 provided by cloud computing environment 50 is shown. It should be understood in advance that the components, layers, and functions shown in FIG. 5 are intended to be illustrative only and embodiments of the present disclosure are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and modifying and processing natural language queries and obtaining user feedback 96. Modifying natural language queries to remove and obtaining user feedback 96 may relate to detecting implicit intent in a received natural language query by running the received natural language query through a domain-agnostic reasoning engine, and providing a modified natural language query including an inference to a user to obtain feedback on the modified natural language query.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-based method of processing natural language queries includes:
receiving a natural language query from a user;
automatically detecting whether the received natural language query includes an implicit intent using a reasoning engine, wherein the reasoning engine comprises domain-agnostic algorithms including domain-agnostic reasoning axioms;
in response to detecting implicit intent in the received natural language query, automatically generating a modified query including a default inference from an interpretation fact sheet;
automatically presenting the modified query to the user and prompting the user via an interface to provide user feedback on the modified query;
in response to receiving user feedback indicating an approval of the modified query, automatically generating a final output;
in response to receiving user feedback indicating a rejection of the modified query, automatically determining an alternative inference and presenting a further modified query including the alternative inference to the user; and
automatically storing information obtained from the feedback in a fact history repository.

2. The computer-based method of claim 1, wherein the interpretation fact sheet comprises default measurements, parameters, and configurations.

3. The computer-based method of claim 1, wherein in response to detecting implicit intent in the received natural language query, automatically generating a modified query including a default inference from an interpretation fact sheet further comprises:
using an inference engine to determine an alternative inference in view of one or more domain-specific ontologies.

4. The computer-based method of claim 1, further comprising:
automatically generating and updating confidence scores for a plurality of potential inferences based on the stored information in the fact history repository.

5. The computer-based method of claim 1, wherein automatically detecting whether the received natural language query includes the implicit intent using the reasoning engine further comprises:
performing a consistency check to detect whether a violation of the domain-agnostic reasoning axioms occurs.

6. The computer-based method of claim 1, wherein automatically presenting the modified query to the user and prompting the user to provide the user feedback on the modified query further comprises:
automatically generating a drop-down list including one or more alternative inferences and asking the user for feedback.

7. The computer-based method of claim 1, wherein automatically storing information obtained from the user feedback in the fact history repository further comprises:
automatically generating user-specific data sets including user-specific confidence scores for alternative inferences.

8. A computer system, the computer system comprising:
one or more processors, one or more computer-readable memories, one or more computer-readable tangible storage medium, and program instructions stored on at least one of the one or more computer-readable tangible storage medium for execution by at least one of the one or more processors via at least one of the one or more computer-readable memories, wherein the computer system is capable of performing a method comprising:
receiving a natural language query from a user;
automatically detecting whether the received natural language query includes an implicit intent using a reasoning engine, wherein the reasoning engine comprises domain-agnostic algorithms including domain-agnostic reasoning axioms;
in response to detecting implicit intent in the received natural language query, automatically generating a modified query including a default inference from an interpretation fact sheet;
automatically presenting the modified query to the user and prompting the user via an interface to provide user feedback on the modified query;
in response to receiving user feedback indicating an approval of the modified query, automatically generating a final output;
in response to receiving user feedback indicating a rejection of the modified query, automatically determining an alternative inference and presenting a further modified query including the alternative inference to the user; and
automatically storing information obtained from the feedback in a fact history repository.

9. The computer system of claim 8, wherein the interpretation fact sheet comprises default measurements, parameters, and configurations.

10. The computer system of claim 8, wherein in response to detecting implicit intent in the received natural language query, automatically generating a modified query including a default inference from an interpretation fact sheet further comprises:
using an inference engine to determine an alternative inference in view of one or more domain-specific ontologies.

11. The computer system of claim 8, wherein the method further comprises:
automatically generating and updating confidence scores for a plurality of potential inferences based on the stored information in the fact history repository.

12. The computer system of claim 8, wherein automatically detecting whether the received natural language query includes the implicit intent using the reasoning engine further comprises:
performing a consistency check to detect whether a violation of the domain-agnostic reasoning axioms occurs.

13. The computer system of claim 8, wherein automatically presenting the modified query to the user and prompting the user to provide the user feedback on the modified query further comprises:
automatically generating a drop-down list including one or more alternative inferences and asking the user for feedback.

14. The computer system of claim 8, wherein automatically storing information obtained from the feedback in the fact history repository further comprises:
automatically generating user-specific data sets including user-specific confidence scores for alternative inferences.

15. A computer program product, the computer program product comprising:
one or more computer-readable tangible storage medium and program instructions stored on at least one of the one or more computer-readable tangible storage medium, the program instructions executable by a processor capable of performing a method, the method comprising:
receiving a natural language query from a user;
automatically detecting whether the received natural language query includes an implicit intent using a reasoning engine, wherein the reasoning engine comprises domain-agnostic algorithms including domain-agnostic reasoning axioms;
in response to detecting implicit intent in the received natural language query, automatically generating a modified query including a default inference from an interpretation fact sheet;
automatically presenting the modified query to the user and prompting the user via an interface to provide user feedback on the modified query;
in response to receiving user feedback indicating an approval of the modified query, automatically generating a final output;
in response to receiving user feedback indicating a rejection of the modified query, automatically determining an alternative inference and presenting a further modified query including the alternative inference to the user; and
automatically storing information obtained from the feedback in a fact history repository.

16. The computer program product of claim 15, wherein the interpretation fact comprises default measurements, parameters, and configurations.

17. The computer program product of claim 15, wherein in response to detecting implicit intent in the received natural language query, automatically generating a modified query including a default inference from an interpretation fact sheet further comprises:
using an inference engine to determine an alternative inference in view of one or more domain-specific ontologies.

18. The computer program product of claim 15, wherein the method further comprises:
automatically generating and updating confidence scores for a plurality of potential inferences based on the stored information in the fact history repository.

19. The computer program product of claim 15, wherein automatically detecting whether the received natural language query includes the implicit intent using the reasoning engine further comprises:
performing a consistency check to detect whether a violation of the domain-agnostic reasoning axioms occurs.

20. The computer program product of claim 15, wherein automatically presenting the modified query to the user and prompting the user to provide the user feedback on the modified query further comprises:
automatically generating a drop-down list including one or more alternative inferences and asking the user for feedback.
